(19) United States
(12) Patent Application Publication
(10) Pub. No.: US 2013/0249953 A1
(43) Pub. Date: Sep. 26, 2013

(54) COMPUTER-READABLE MEDIUM, INFORMATION PROCESSING DEVICE, INFORMATION PROCESSING SYSTEM, AND DISPLAY CONTROL METHOD

(71) Applicant: NINTENDO CO., LTD., Kyoto (JP)

(72) Inventors: Hideaki SHIMIZU, Kyoto (JP); Yasuhiko MATSUZAKI, Kyoto (JP)

(73) Assignee: NINTENDO CO., LTD., Kyoto (JP)

(21) Appl. No.: 13/848,508

(22) Filed: Mar. 21, 2013

(30) Foreign Application Priority Data
Mar. 21, 2012 (JP) 2012-063166

(51) Int. Cl. G09G 5/38

(52) U.S. Cl. CPC G09G 5/38
USPC 345/681

(57) ABSTRACT

An example system causes a computer to execute: operation acceptance for accepting a first movement operation to move an object displayed in a folder area to a buffer area and a second movement operation to return the object moved to the buffer area, to the folder area; and display control in which when the first movement operation is accepted, an object in a selected state among the objects displayed arranged in the folder area is moved to the buffer area, and when the second movement operation is accepted, at least one of the objects displayed in the buffer area is moved to a predetermined position in the folder area in an order in accordance with a movement order of the first movement operation.

This application is based upon and claims the benefit of priority of the prior Japanese Patent Application No. JP2012-063166, filed on Mar. 21, 2012, the entire contents of which are incorporated herein by reference.

### FIELD

The present disclosure relates to object display control.

### BACKGROUND AND SUMMARY

An example of an information processing program according to the present disclosure is a program for causing a computer of an information processing device that causes a display device to display an object, to function as: a display control unit for performing display control of a plurality of objects with respect to the display device; a first movement operation accepting unit for accepting a first movement operation to move an object displayed in a first area in a display area of the display device to a second area in the display area; a second movement operation accepting unit for accepting a second movement operation to return an object that has been moved to the second area, to the first area; and a selection operation accepting unit for accepting a selection operation to change a desired object among the objects displayed arranged in the first area, to a selected state; wherein when the first movement operation is accepted, the display control unit moves an object in a selected state among the objects displayed arranged in the first area, to the second area, and when the second movement operation is accepted, the display control unit moves at least one of the objects displayed in the second area, to a predetermined position in the first area in an order in accordance with a movement order of the first movement operation.

In this case, an object refers to a display object such as an icon, a photograph, a document, and a character that is displayed by a display device.

In order to change a display order of objects displayed in the first area, a computer according to the present disclosure uses an operation for moving an object to the second area and an operation for returning an object that has been moved to the second area, to the first area.

In addition, the present disclosure enables the display order of objects to be changed by a simple operation of returning objects that have been moved to the second area to the first area in an order in accordance with a movement order in which the movement to the second area had been performed.

Furthermore, the computer may be connected to an input device, and the first movement operation, the second movement operation, and the selection operation may be respectively assigned to different input operations performed using the input device.

Moreover, the input device may be an input device for indicating directions, and the first movement operation, the second movement operation, and the selection operation may be respectively assigned to directions indicated using the input device.

By associating each of the first movement operation, the second movement operation, and the selection operation to a direction indicated using the input device, a user can change a display order of objects by performing only an operation for indicating a direction.

Furthermore, an indicated direction that is associated with each of the operations is favorably determined according to a positional relationship of an object or an area related to each operation. In other words, an operation for moving an object is favorably associated with a movement direction of the object in the display area. Since an indicated direction that is associated with each operation corresponds to a positional relationship of an object or an area related to each operation, a user can change a display order of objects by an intuitive operation for indicating a direction.

For example, when the second area is positioned above the first area, favorably, the first movement operation for moving an icon from the first area to the second area is associated with an operation for indicating an upward direction and the second movement operation for moving an icon from the second area to the first area is associated with an operation for indicating a downward direction. In addition, when objects are arranged from left to right in the first area, the selection operation is favorably associated with an operation for indicating a leftward or rightward direction.

Furthermore, the selection operation may include a first selection operation and a second selection operation, the first movement operation and the second movement operation may be assigned to opposite directions indicated using the input device, and the first selection operation and the second selection operation may be assigned to opposite directions indicated using the input device.

Since a combination of the first movement operation and the second movement operation and a combination the first selection operation and the second selection operation which are combinations of opposite operations are respectively associated to opposite directions, a user can intuitively perform a movement operation and a selection operation of an object.

In addition, the directions assigned to the first movement operation and the second movement operation may be perpendicular to the directions assigned to the first selection operation and the second selection operation.

Furthermore, when the first movement operation is accepted and the object in a selected state is moved to the second area, the display control unit may newly change, to a selected state, an object adjacent in a predetermined direction to the object that had been in a selected state immediately before the movement, and when the second movement operation is accepted, the display control unit may move an object displayed in the second area to a position adjacent in an opposite direction of the predetermined direction to the object in a selected state.

Accordingly, by performing a second movement operation, a most recent first movement operation can be canceled, and by performing a first movement operation, a most recent second movement operation can be canceled.

In addition, the object in a selected state may be an object displayed at the predetermined position, and when the selection operation is accepted, the display control unit may move one of the objects displayed arranged in the first area to the predetermined position in order to change the desired object to a selected state.

By accepting a selection operation and changing a desired object to a selected state according to the selection operation, an object that is a movement object can be specified by a simple operation. In addition, by changing an object displayed at a predetermined position to an object in a selected state, a position to which a buffered object is returned can be specified with a same operation as an object selection operation.

Furthermore, when the second movement operation is accepted, the display control unit may move objects displayed in the second area to the predetermined position in the first area in a same order as the movement order of the first movement operation or in an opposite order to the movement order of the first movement operation.

In other words, when the second movement operation is accepted, if the objects displayed in the second area are moved to the first area in a same order as the movement order of the first movement operation, the second area functions as a queue of the objects, and if the objects displayed in the second area are moved to the first area in an opposite order to the movement order of the first movement operation, the second area functions as a stack of the objects.

In addition, the display control unit may display the objects moved from the first area, in the second area in an order in accordance with the movement order of the first movement operation.

Adopting an order in accordance with the movement order of the first movement operation as a display order of objects in the second area enables a user to intuitively grasp that the second area functions as a queue or a stack of objects.

Furthermore, the computer may be configured so as to further function as a replacement operation accepting unit for accepting a replacement operation to replace an object group displayed arranged in the first area with another object group, and when the replacement operation is accepted, the display control unit may replace an object group displayed arranged in the first area with another object group.

By replacing an object group displayed arranged in the first area with another object group, an object belonging to a given object group may be moved to another object group.

In addition, the display control unit may display objects representing data managed using data management information in the first area in an arrangement in accordance with the data management information, and the computer may be configured so as to further function as an information updating unit for updating, when a display arrangement of the objects in the first area changes as a result of the display control, the data management information in accordance with the display arrangement of the objects after the change.

In this case, examples of the data managed using data management information include a file handled by the computer, and examples of an object include an icon representing such a file. Due to the computer executing an information update in accordance with a display arrangement of objects, a display order of data such as files can be reordered and a result of the reordering can be stored by simple operations.

Furthermore, the first area may be a substantial area in which the objects are displayed in accordance with the data management information, and the second area may be a buffer area for temporarily storing an object whose display position is to be changed.

Moreover, the present disclosure may also be comprehended as an information processing device, an information processing system comprising one or a plurality of information processing devices, a method executed by a computer, and a program to be executed by the computer.

In addition, the present disclosure may be a recording medium which is readable by a device, machine, and the like such as a computer and in which the program is recorded. In this case, a recording medium readable by a computer or the like refers to a recording medium which accumulates information such as data and programs by an electric action, a magnetic action, an optical action, a mechanical action, or a chemical action and which can be read by a computer or the like.

### BRIEF DESCRIPTION OF THE DRAWINGS

FIG. 1 is a diagram showing an example non-limiting outline of a hardware configuration of an information processing device;

FIG. 2 is a diagram showing an example non-limiting outline of a functional configuration of an information processing device;

FIG. 3 is a diagram showing an example non-limiting configuration of a file management screen;

FIG. 4 is a flow chart showing an example non-limiting flow of an icon reordering process;

FIG. 5 is a diagram showing an example non-limiting transition of a file management screen; and

FIG. 6 is a flow chart showing an example non-limiting flow of an icon reordering process according to a variation.

### DETAILED DESCRIPTION OF NON-LIMITING EXAMPLE EMBODIMENTS

Hereinafter, non-limiting example embodiments of the present disclosure will be described with reference to the drawings. The example embodiments described below represent exemplary implementations of the present disclosure. Therefore, it is to be understood that the present disclosure is not limited to the specific configurations described below. When implementing the present disclosure, specific configurations may be adopted in accordance with various embodiments as appropriate. For example, while the present disclosure can be applied to an information processing program executed by a general computer, a general information processing device, a general information processing system comprising one or a plurality of information processing devices, a general information processing method, and the like, the present disclosure can also be applied to a game program, a game device, a game system, and a game method.

<Device Configuration>

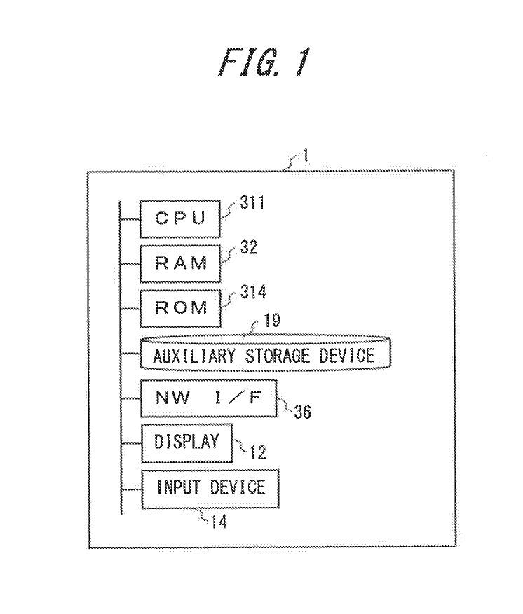

FIG. 1 is a diagram showing an outline of a hardware configuration of an information processing device 1 according to the present embodiment. The information processing device 1 is an information processing device in which a CPU (Central Processing Unit) 311, a RAM (Random Access Memory) 32, a ROM (Read Only Memory) 314, an auxiliary storage device 19, a network interface 36 for performing communication with the outside via a network, a display 12, and an input device 14 such as a four-way button are electrically connected to each other. Moreover, components of a specific hardware configuration of the information processing device 1 may be omitted, replaced, or added as appropriate in accordance with various embodiments.

The CPU 311 is a central processing unit which controls the respective components constituting the information processing device 1 such as the RAM 32 and the auxiliary storage device 19 by processing commands and data expanded in the RAM 32, the ROM 314, and the like. In addition, the RAM 32 is a main storage unit controlled by the CPU 311. Various commands and data are written into and read out from the RAM 32. In other words, the CPU 311, the RAM 32, and the ROM 314 constitute a control unit of the information processing device 1.

The auxiliary storage device 19 is a non-volatile storage device. Information that is desirably retained even when the information processing device 1 is shut down including an OS (Operating System) of the information processing device 1 that is loaded to the RAM 32, various programs for executing the processes described later, and various data used by the information processing device 1 are mainly written into and read out from the auxiliary storage device 19. For example, an EEPROM (Electrically Erasable Programmable ROM) or an HDD (Hard Disk Drive) can be used as the auxiliary storage device 19. Alternatively, a portable medium that is detachably mounted to the information processing device 1 maybe used as the auxiliary storage device 19. Examples of a portable medium include an EEPROM-based memory card, a CD (Compact Disc), a DVD (Digital Versatile Disc), and a BD (Blu-ray Disc). A combination of an auxiliary storage device 19 that is a portable medium and a non-portable auxiliary storage device 19 may also be used.

In the present embodiment, a case will be described in which a four-way button that enables operations for indicating the four directions of upward, downward, leftward, and rightward is used as the input device 14. However, the input device 14 is not limited to a four-way button. For example, the input device 14 may be cursor keys provided on a keyboard, a mouse, a touch panel provided on the display 12, or the like (not shown).

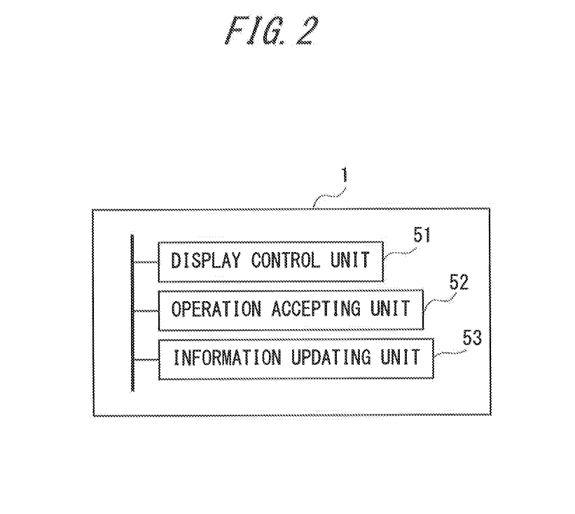

Next, functions of the information processing device 1 according to the present embodiment will be described. FIG. 2 is a diagram showing an outline of a functional configuration of the information processing device 1 according to the present embodiment. Due to the CPU 311 interpreting and executing various programs expanded on the RAM 32, the information processing device 1 according to the present embodiment functions as an information processing device comprising a display control unit 51, an operation accepting unit 52, and an information updating unit 53. The operation accepting unit 52 accepts user operations. In addition, the display control unit 51 controls display of an icon 63 corresponding to an object according to the present disclosure on the display 12 in accordance with a user operation or the like accepted by the operation accepting unit 52. Furthermore, the information updating unit 53 updates data management information based on a result of the display control by the display control unit 51. While an example in which all of these functions are executed by the general-purpose CPU 311 is described in the present embodiment, a part of or all of these functions may be realized by one or a plurality of dedicated processors.

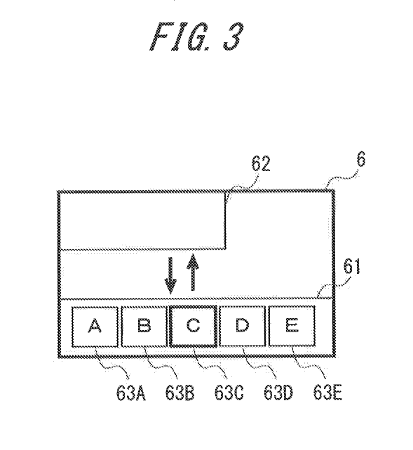

FIG. 3 is a diagram showing a configuration of a file management screen 6 displayed on the display 12 in the present embodiment. The file management screen 6 is displayed when a user operation for opening a specified folder is accepted. In the file management screen 6 according to the present embodiment, a lower part of the screen is used as a folder area (a first area) 61 and an upper-left part of the screen is used as a buffer area (a second area) 62.

The folder area 61 is an area for displaying icons 63 of files contained in a specified folder. In the present embodiment, icons 63 representing files in a folder are displayed arranged from left to right in the folder area 61 in a state where the folder is opened (hereinafter referred to as an “initial state”). An arrangement order of the icons 63 in the initial state is determined in accordance with data management information (not shown). In addition, in the folder area 61, any of the arranged icons 63 (for example, an icon 63 at a predetermined position) is changed to a selected state. In the present embodiment, the icon 63 positioned at the center of the folder area 61 changes to a selected state. As will be described later, the icon 63 in a selected state can be changed by a user operation.

The buffer area 62 is an area for retaining icons 63 moved from the folder area 61. In the initial state, icons 63 are not displayed in the buffer area 62. However, when icons 63 are moved from the folder area 61 to the buffer area 62 in an icon reordering process described later, icons 63 are displayed arranged from right to left in the buffer area 62. At this point, the arrangement order of the icons 63 in the buffer area 62 is an order in accordance with a movement order of a buffer operation such as a same order as or an opposite order to the movement order of the buffer operation. In addition, in the icon reordering process described later, icons 63 moved to the buffer area 62 can be returned to the folder area 61. In the present embodiment, an order in which icons 63 are added to or removed from the buffer area 62 is an opposite order to the movement order of the buffer operation or, in other words, LIFO (Last In First Out), and the buffer area 62 functions as a stack. However, the order in which icons 63 are added to or removed from the buffer area 62 is not limited to LIFO. The display control unit 51 need only move at least one icon 63 among the icons 63 displayed in the buffer area 62 to a predetermined position in the folder area 61 in an order in accordance with the movement order of a buffer operation (for example, a same order as the movement order of the buffer operation or an opposite order to the movement order of the buffer operation). For example, the order in which icons 63 are added to or removed from the buffer area 62 may be the same order as the movement order of the buffer operation or, in other words, FIFO (First In First Out), in which case the buffer area 62 may function as a queue.

In addition, arrows that enable a user to visually grasp destinations of an icon 63 in a buffer operation and a return operation described later are displayed on the file management screen 6. Among the arrows displayed on the file management screen 6 shown in FIG. 3, an arrow indicating an upward direction is an arrow which indicates a destination of an icon 63 when the icon 63 is moved from the folder area 61 to the buffer area 62 by a buffer operation and which indicates a right end of the buffer area 62. Due to such arrows, the user is able to intuitively comprehend that a buffer operation is a stack operation to the buffer area. In addition, an arrow indicating a downward direction is an arrow which indicates a destination of an icon 63 when the icon 63 is returned to the folder area 61 from the buffer area 62 by a return operation and which indicates a position between an icon 63 in a selected state and an icon 63 adjacent to the left of the icon 63 in a selected state. Due to such an arrow, the user is able to intuitively comprehend that a destination of an icon in a return operation is a position between the icon 63 in a selected state and the icon 63 adjacent to the left of the icon 63 in a selected state. Furthermore, with both the upward arrow and the downward arrow, a base of the arrow indicates an icon that is a movement object.

<Flow of Processes>

Next, a flow of processes executed in the present embodiment will be described. Moreover, specific contents, order, and the like of the processes shown in flow charts according to the present embodiment represent an example of implementing the present disclosure. As such, the specific contents and order of the processes may be appropriately selected in accordance with various embodiments of the present disclosure.

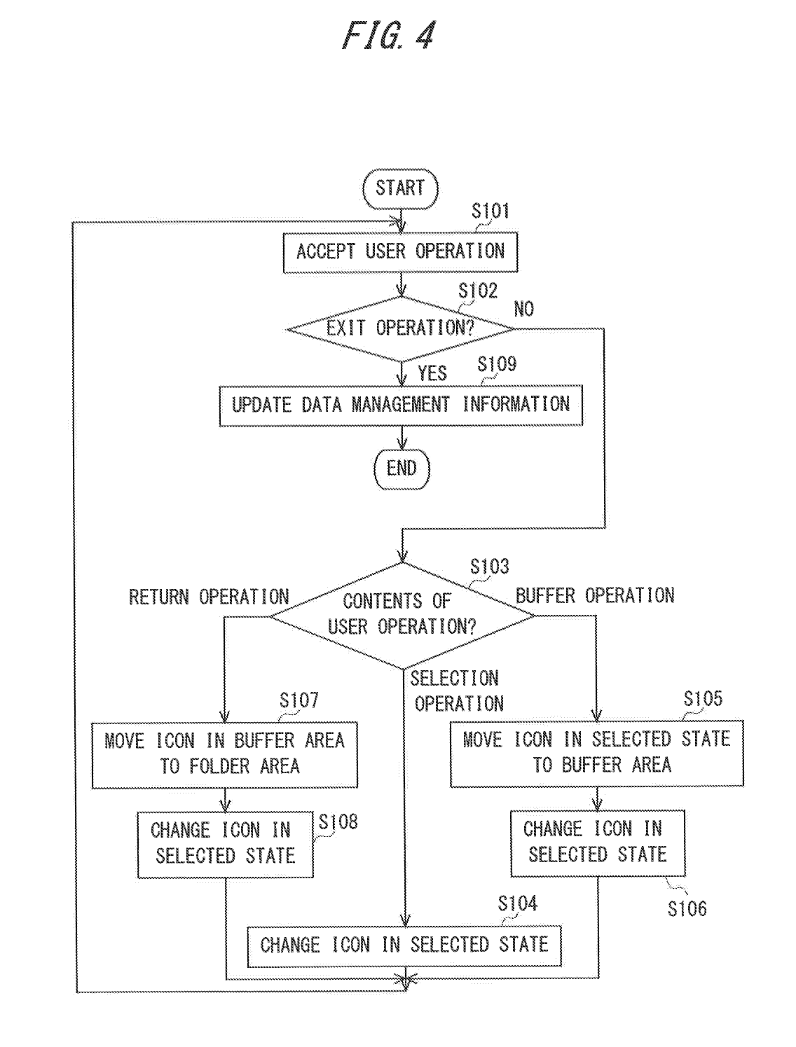

FIG. 4 is a flow chart showing a flow of an icon reordering process according to the present embodiment. The icon reordering process shown in the present flow chart is executed during the execution of an application or the like by the information processing device 1 when an operation for opening a folder in which files are managed is performed and the file management screen 6 shown in FIG. 3 is displayed.

In step S101, an operation by a user is accepted. The operation accepting unit 52 accepts an operation by the user via the input device 14. Specifically, the operation accepted at this point is any of a selection operation, an icon movement operation, and an exit operation. In addition, an icon movement operation includes a buffer operation (a first movement operation) that is an icon movement operation from the folder area 61 to the buffer area 62 and a return operation (a second movement operation) that is an icon movement operation from the buffer area 62 to the folder area 61. For example, the operation accepting unit 52 records operation content identification information that is information capable of identifying a button or the like operated by the user in the RAM 32. In the present embodiment, since the respective operations described above are associated with operation content identification information in advance, the display control unit is able to determine which of the respective operations described above the user's operation corresponds to by referring to the operation content identification information.

Among these operations, a selection operation and icon movement operations (a buffer operation and a return operation) are associated with cursor keys or respective directional buttons constituting a four-way button, and an operation corresponding to a direction indicated using the four-way button is accepted. On the file management screen 6 shown in FIG. 3, since icons 63 in the folder area 61 are arranged from left to right in an order in accordance with data management information, a selection operation is associated to a left button and a right button of the four-way button. In addition, in the layout of the file management screen 6, since the buffer area 62 is arranged on an upper side of the folder area 61 (in other words, the folder area 61 is arranged on a lower side of the buffer area 62; refer to FIG. 3), an icon movement operation from the folder area 61 to the buffer area 62 is associated with an up button of the four-way button and an icon movement operation from the buffer area 62 to the folder area 61 is associated with a down button of the four-way button. Due to the respective operations being associated with up, down, left, and right buttons in accordance with the layout of the file management screen 6 in this manner, the user can reorder icons by performing intuitive operations.

In step S102, a determination is made on whether or not the user operation accepted in step S101 is an exit operation or, in other words, an operation for closing the file management screen 6 shown in FIG. 3. Specifically, an exit operation is a pressing operation of a predetermined cancel button or the like. When it is determined that the user operation is an exit operation, the process proceeds to step S109. On the other hand, when it is determined that the user operation is not an exit operation, the process proceeds to step S103.

In step S103, contents of the user operation is determined. The display control unit determines whether the user operation accepted in step S101 is any of a selection operation, a buffer operation (an icon movement operation from the folder area 61 to the buffer area 62), and a return operation (an icon movement operation from the buffer area 62 to the folder area 61). Although any method may be adopted as a specific determination method, for example, the display control unit determines contents of the user operation by referring to the operation content identification information recorded in the RAM 32 in step S101. When it is determined that the user operation is a selection operation, the process proceeds to step S104. When it is determined that the user operation is a buffer operation, the process proceeds to step S105. When it is determined that the user operation is a return operation, the process proceeds to step S107.

In step S104, the icon in a selected state is changed. The display control unit 51 changes the icon in a selected state in accordance with the contents of the selection operation. In the present embodiment, when the user presses the left button once, an icon group arranged in the folder area 61 moves to the right by one. As a result, an icon 63 on the left side of the icon 63 that had been in a selected state prior to the depression of the button moves to a predetermined position (in the present embodiment, the center) of the folder area 61 and newly changes to a selected state. In addition, when the user continues pressing the left button for a predetermined period of time or longer, the icon group arranged in the folder area 61 continues to move to the right until the depression by the user is released. In this case, the icon 63 at the predetermined position (center) of the folder area 61 at the time of release of depression newly changes to a selected state. Furthermore, a pressing operation of the right button is approximately the same as a pressing operation of the left button with the sole exception of a movement direction of the icon group being opposite (leftward) to a pressing operation of the left button. By performing such selection operations, the user can change a desired icon 63 to a selected state. Once the change of the icon in a selected state in accordance with the user operation is completed, the process returns to step S101.

In steps S105 and S106, the icon in a selected state is moved to the buffer area 62 and, accordingly, the icon in a selected state is changed. The display control unit 51 moves the icon 63 that is in a selected state at the time a buffer operation is accepted among the icons 63 displayed arranged in the folder area 61 from the folder area 61 to the buffer area 62 (step S105). In the present embodiment, since the buffer area 62 adopts LIFO (stack) as an order of adding and removing icons, the icon 63 is moved from the folder area 61 to a rightmost position in the buffer area 62. In the present embodiment, icons 63 are similarly displayed arranged from left to right in the buffer area 62, and a right hand side of the buffer area 62 corresponds to an upper level side of a stack. In other words, the icon 63 is moved to an uppermost level of the stack of the buffer area 62.

Since the icon 63 moved in accordance with a buffer operation moves to the rightmost position in the buffer area 62 in this manner, an arrangement order of the icons 63 in the buffer area 62 assumes an order in accordance with the movement order of a buffer operation (in the present embodiment, the same order as the movement order of a buffer operation).

Once the icon in a selected state is moved from the folder area 61 to the buffer area 62, another icon 63 changes to a selected state in the folder area 61 (step S106). In the present embodiment, an icon 63 positioned to the right of the moved icon 63 is newly moved to a predetermined position (in this case, the center) of the folder area 61 and is changed to a selected state. However, the icon 63 that is changed to a selected state with the movement may be selected according to other rules. For example, an icon 63 positioned to the left of the moved icon 63 may be changed to a selected state. Subsequently, the process returns to step S101.

In steps S107 and S108, an icon 63 in the buffer area 62 is moved to the folder area 61 and, accordingly, the icon in a selected state is changed. The display control unit 51 moves the icon 63 at the uppermost level of the stack in the buffer area 62 (in the present embodiment, the rightmost position in the buffer area 62) at the time a return operation is accepted from the buffer area 62 to the folder area 61 (step S107). Accordingly, the icon 63 at the uppermost level of the stack is changed in the buffer area 62. Moreover, in the present embodiment, the icon 63 that is moved from the buffer area 62 to the folder area 61 is moved to a predetermined position (in this case, the center) of the folder area 61. Therefore, the icon 63 in a selected state as well as the icons 63 arranged to the right of the icon 63 in a selected state at the time the return operation is accepted are all shifted to the right by one in the folder area 61.

Once the icon 63 is moved from the buffer area 62 to the folder area 61, the moved icon 63 assumes a predetermined position (in this case, the center) of the folder area 61 and changes to a selected state (step S108). However, the icon 63 that changes to a selected state with the movement may be selected according to other rules. Subsequently, the process returns to step S101.

In other words, with the process shown in the present flow chart, a reordering of the icons 63 is performed by repetitively performing the processes of steps S101 to S108. In the present embodiment, since the respective operations for reordering icons with the exception of an exit operation are assigned to four buttons (for example, up, down, left, and right buttons of a four-way button), the user can perform a reordering operation of files by simple button operations alone.

In addition, in the present embodiment, due to the movement of the icon in a selected state from the folder area 61 to the uppermost level of the stack of the buffer area 62 in accordance with a buffer operation, an icon most recently moved to the buffer area 62 becomes a return operation object icon. Therefore, in the present embodiment, the user is able to cancel a most recent buffer operation by simply performing a return operation. Furthermore, in the present embodiment, the icon 63 that has moved to the folder area 61 in accordance with a return operation becomes the icon in a selected state. Therefore, in the present embodiment, the user is able to cancel a most recent return operation by simply performing a buffer operation. Moreover, in the present embodiment, by performing the icon movements described above, a plurality of most recent buffer operations can be canceled by performing a same number of return operations, and a plurality of most recent return operations can be canceled by performing a same number of buffer operations.

In step S109, the data management information is updated. The information updating unit 53 updates the data management information according to a result of reordering of icons performed by repeating the processes of steps S101 to S108. In other words, when the display arrangement of the icons 63 in the folder area 61 has changed as a result of the reordering of icons, the information updating unit 53 updates the data management information with the order of the display arrangement after the change. Subsequently, the process shown in the present flow chart is terminated and the file management screen 6 is closed. Therefore, when a folder is next opened, the arrangement order of the icons 63 is determined according to the updated data management information.

Moreover, while an example has been described in the present embodiment in which a timing of acceptance of an exit operation is adopted as a timing of updating the data management information, various timings may be adopted in accordance with various embodiments as the timing of updating the data management information. For example, the data management information may be updated every time display contents of the folder area changes or may be updated regularly.

A specific example of a reordering of icons by the icon reordering process shown in the aforementioned flow chart will now be described.

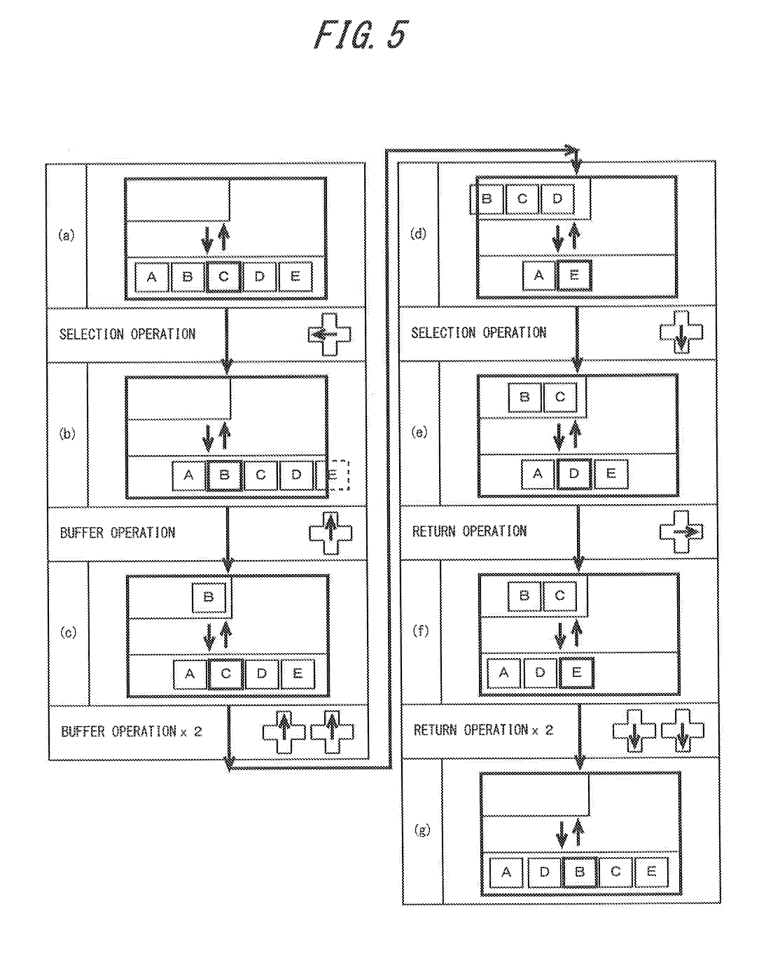

FIG. 5 is a diagram showing an example of a transition of the file management screen 6 when a reordering of icons is performed by the icon reordering process according to the present embodiment.

A case will be described in which a folder including five files from file A to file E is opened. An arrangement order of the files is retained in an order from file A to file E in the data management information, and icons 63A to 63E which represent the files A to E are arranged with reference to the data management information. Therefore, in an initial state, the icons 63 are arranged from left to right in an order of the icons 63A to 63E. In addition, the icon 63 in a selected state in the initial state is the icon 63C (refer to (a) in FIG. 5).

At this point, when the left button of the four-way button is pressed by the user (selection operation), the icons 63A to 63E all shift to the right by one and the icon 63B to the left of the icon 63C that had been in a selected state prior to the pressing of the left button changes to a selected state (refer to (b) in FIG. 5).

When the up button of the four-way button is pressed by the user (buffer operation) in a state where the icon 63B is selected, the icon 63B in a selected state is moved from the folder area 61 to the buffer area 62. Furthermore, in the folder area 61, the icon 63C that had been adjacent to the right of the icon 63B changes to a selected state (refer to (c) in FIG. 5). When the user further presses the up button of the four-way button twice (buffer operation), the icon 63C and the icon 63D are consecutively moved to the buffer area 62 and the icon 63E becomes the icon in a selected state (refer to (d) in FIG. 5). In this case, since the buffer area 62 is a stack and a right hand side of the buffer area 62 corresponds to an upper level of the stack, icons 63B, 63C, and 63D are arranged from left to right in the buffer area 62.

At this point, when the down button of the four-way button is pressed by the user (return operation), the icon 63D at the uppermost level of the stack of the buffer area 62 moves to a position between the icon 63A and the icon 63E indicated by a downward arrow on the file management screen 6. In addition, the icon 63D having moved to a position between the icon 63A and the icon 63E moves to the center of the folder area 61 and changes to a selected state, and the icon 63E moves to the right (refer to (e) in FIG. 5).

In this state, when the right button of the four-way button is pressed by the user (selection operation), the icons 63A, 63D, and 63E all shift to the left by one and the icon 63E to the right of the icon 63D that had been in a selected state prior to the pressing of the right button changes to a selected state (refer to (f) in FIG. 5). Moreover, the selection operation performed at this point is an operation by the user to specify a position to which a buffered icon 63 is returned.

After determining the position to which the icon 63 is to be returned, when the down button of the four-way button is pressed two more times by the user (return operation), icons 63C and 63B are sequentially moved starting from the uppermost level of the stack of the buffer area 62 to the position of the icon in a selected state in the folder area 61. The icon 63B moved last moves to the center of the folder area 61 and changes to a selected state, and the icon 63E moves to the right (refer to (g) in FIG. 5).

In this state, icons 63 are arranged in the folder area 61 in an order of the icon 63A, the icon 63D, the icon 63B, the icon 63C, and the icon 63E. When an exit operation is accepted, the current arrangement of the icons 63 in the folder area 61 is recorded in the data management information as order information of the files in the folder. In this manner, the user can reorder files in a desired order and save the arrangement order.

<Advantageous Effect>

According to the processes shown in the present embodiment, a display order of the icons 63 can be changed and the data management information can be updated by a simple operation that only involves indicating directions using a four-way button and without having to perform operations in order to determine an object to be moved and a destination of the movement and to perform a drag-and-drop operation using a pointing device or the like. In addition, when such a user interface is applied to a game device comprising a controller with which, for example, a four-way button is operated by one hand (for example, the left hand) and a select button or the like is operated by the other hand (for example, the right hand), a user can change a display order of the icons 63 and update the data management information by operations that only require one hand.

<Variation of Embodiment>

Hereinafter, a variation applicable to the embodiment above will be described.

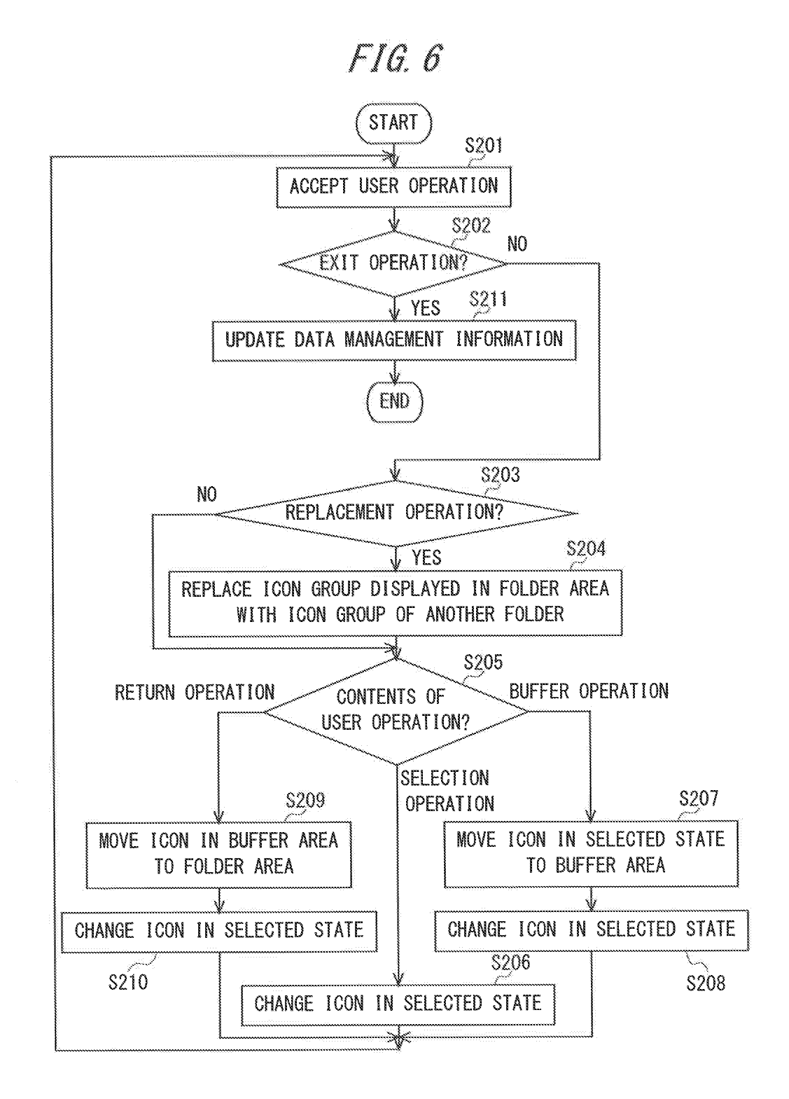

FIG. 6 is a flow chart showing a flow of an icon reordering process according to the variation. The icon reordering process shown in the present flowchart is executed during the execution of an application or the like by the information processing device 1 when an operation for opening a folder in which files are managed is performed and the file management screen 6 shown in FIG. 3 is displayed.

Since processes of steps S201 and S202 are approximately the same as the processes of steps S101 and S102 described earlier with reference to FIG. 4, a description thereof will be omitted. However, when it is determined in step S202 that the user operation is not an exit operation, the process proceeds to step S203.

In steps S203 and S204, a determination is made on whether or not the user operation accepted in step S201 is a replacement operation and, if the operation is a replacement operation, replacement of an icon group displayed in the folder area 61 is performed. Specifically, a replacement operation is an operation in which the user specifies a desired folder and presses the select button or the like. When the user operation is determined to be a replacement operation, the display control unit 51 replaces the icon group displayed in the folder area 61 with an icon group of files included in a different folder from a folder that had been a display object at the time the replacement operation was accepted.

On the other hand, when it is determined that the user operation is not a replacement operation, the process proceeds to step S205. Since processes of steps S205 to S211 are approximately the same as the processes of steps S103 to S109 described earlier with reference to FIG. 4, a description thereof will be omitted.

In other words, in the present variation, a replacement operation for replacing an icon group displayed arranged in the folder area 61 with an icon group related to another folder is further accepted, and when a replacement operation is accepted, the icon group displayed arranged in the folder area 61 is replaced with an icon group related to another folder. Accordingly, files belonging to a given folder can be moved to another folder with a simple operation.

In addition, the layout of a folder management screen and indicated directions associated with the respective operations are not limited to the layout and the indicated directions described in the embodiment above. For example, the folder area 61 and the buffer area 62 may be respectively arranged on the left hand side and the right hand side of the display 12 and the left and right buttons of the four-way button may be respectively assigned to a return operation and a buffer operation, or icons 63 may be arranged from top to bottom and the up and down buttons of the four-way button may be assigned to a selection operation. In addition, the layout of the folder management screen and indicated directions associated with the respective operations may be modified as appropriate in accordance with various implementations.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A computer-readable non-transitory medium on which is recorded an information processing program for causing a computer of an information processing device that causes a display device to display an object, to function as:
a display control unit for performing display control of a plurality of objects with respect to the display device;
first movement operation accepting unit for accepting a first movement operation to move an object displayed in a first area in a display area of the display device to a second area in the display area;
a second movement operation accepting unit for accepting a second movement operation to return an object that has been moved to the second area, to the first area; and
a selection operation accepting unit for accepting a selection operation to change a desired object among the objects displayed arranged in the first area, to a selected state, wherein
when the first movement operation is accepted, the display control unit moves an object in a selected state among the objects displayed arranged in the first area, to the second area, and when the second movement operation is accepted, the display control unit moves at least one of the objects displayed in the second area, to a predetermined position in the first area in an order in accordance with a movement order of the first movement operation.

2. The computer-readable non-transitory medium on which an information processing program is recorded according to claim 1, wherein
the computer is connected to an input device, and
the first movement operation, the second movement operation, and the selection operation are respectively assigned to different input operations performed using the input device.

3. The computer-readable non-transitory medium on which an information processing program is recorded according to claim 2, wherein
the input device is an input device for indicating directions, and
the first movement operation, the second movement operation, and the selection operation are respectively assigned to directions indicated using the input device.

4. The computer-readable non-transitory medium on which an information processing program is recorded according to claim 3, wherein
the selection operation includes a first selection operation and a second selection operation, and
the first movement operation and the second movement operation are assigned to opposite directions indicated using the input device, and the first selection operation and the second selection operation are assigned to opposite directions indicated using the input device.

5. The computer-readable non-transitory medium on which an information processing program is recorded according to claim 4, wherein
the directions assigned to the first movement operation and the second movement operation are perpendicular to the directions assigned to the first selection operation and the second selection operation.

6. The computer-readable non-transitory medium on which an information processing program is recorded according to claim 1, wherein
when the first movement operation is accepted and the object in a selected state is moved to the second area, the display control unit newly changes, to a selected state, an object adjacent in a predetermined direction to the object that had been in a selected state immediately before the movement, and
when the second movement operation is accepted, the display control unit moves an object displayed in the second area to a position adjacent in an opposite direction of the predetermined direction to the object in a selected state.

7. The computer-readable non-transitory medium on which an information processing program is recorded according to claim 1, wherein
the object in a selected state is an object displayed at the predetermined position, and
when the selection operation is accepted, the display control unit moves one of the objects displayed arranged in the first area to the predetermined position in order to change the desired object to a selected state.

8. The computer-readable non-transitory medium on which an information processing program is recorded according to claim 1, wherein
when the second movement operation is accepted, the display control unit moves objects displayed in the second area to the predetermined position in the first area in a same order as the movement order of the first movement operation or in an opposite order to the movement order of the first movement operation.

9. The computer-readable non-transitory medium on which an information processing program is recorded according to claim 1, wherein
the display control unit displays the objects moved from the first area, in the second area in an order in accordance with the movement order of the first movement operation.

10. The computer-readable non-transitory medium on which an information processing program is recorded according to claim 1, wherein
the information processing program further causes the computer to function as a replacement operation accepting unit for accepting a replacement operation to replace an object group displayed arranged in the first area with another object group, and
when the replacement operation is accepted, the display control unit replaces an object group displayed arranged in the first area with another object group.

11. The computer-readable non-transitory medium on which an information processing program is recorded according to claim 1, wherein
the display control unit displays objects representing data managed using data management information in the first area in an arrangement in accordance with the data management information, and
the information processing program further causes the computer to function as an information updating unit for updating, when a display arrangement of the objects in the first area changes as a result of the display control, the data management information in accordance with the display arrangement of the objects after the change.

12. The computer-readable non-transitory medium on which an information processing program is recorded according to claim 11, wherein
the data managed using the data management information is a file handled by the computer, and the object is an icon representing the file.

13. The computer-readable non-transitory medium on which an information processing program is recorded according to claim 11, wherein
the first area is a substantial area in which the objects are displayed in accordance with the data management information, and the second area is a buffer area for temporarily storing an object whose display position is to be changed.

14. An information processing device that causes a display device to display an object, the information processing device comprising:
a display control unit for performing display control of a plurality of objects with respect to the display device;
a first movement operation accepting unit for accepting a first movement operation to move an object displayed in a first area in a display area of the display device to a second area in the display area;
a second movement operation accepting unit for accepting a second movement operation to return an object that has been moved to the second area, to the first area; and
a selection operation accepting unit for accepting a selection operation to change a desired object among the objects displayed arranged in the first area, to a selected state, wherein
when the first movement operation is accepted, the display control unit moves an object in a selected state among the objects displayed arranged in the first area, to the second area, and when the second movement operation is accepted, the display control unit moves at least one of the objects displayed in the second area, to a predetermined position in the first area in an order in accordance with a movement order of the first movement operation.

15. An information processing system that causes a display device to display an object, the information processing system comprising:
a display control unit for performing display control of a plurality of objects with respect to the display device;
a first movement operation accepting unit for accepting a first movement operation to move an object displayed in a first area in a display area of the display device to a second area in the display area;
a second movement operation accepting unit for accepting a second movement operation to return an object that has been moved to the second area, to the first area; and
a selection operation accepting unit for accepting a selection operation to change a desired object among the objects displayed arranged in the first area, to a selected state, wherein
when the first movement operation is accepted, the display control unit moves an object in a selected state among the objects displayed arranged in the first area, to the second area, and when the second movement operation is accepted, the display control unit moves at least one of the objects displayed in the second area, to a predetermined position in the first area in an order in accordance with a movement order of the first movement operation.

16. A display control method for causing a computer of an information processing device that causes a display device to display an object, to execute:
performing display control of a plurality of objects with respect to the display device;
accepting a first movement operation to move an object displayed in a first area in a display area of the display device to a second area in the display area;
accepting a second movement operation to return an object that has been moved to the second area, to the first area; and
accepting a selection operation to change a desired object among the objects displayed arranged in the first area, to a selected state, wherein
in the display control, when the first movement operation is accepted, an object in a selected state among the objects displayed arranged in the first area is moved to the second area, and when the second movement operation is accepted, at least one of the objects displayed in the second area is moved to a predetermined position in the first area in an order in accordance with a movement order of the first movement operation.
